(19) United States
(12) Patent Application Publication
(10) Pub. No.: US 2026/0243927 A1
(43) Pub. Date: Aug. 20, 2026

(54) OPTICAL FILM, OPTICAL ELEMENT, AND OPTICAL DEVICE

(71) Applicant: CANON KABUSHIKI KAISHA, Tokyo (JP)

(72) Inventor: KYOHEI ISHIKAWA, Saitama (JP)

(21) Appl. No.: 19/401,521

(22) Filed: Nov. 26, 2025

(30) Foreign Application Priority Data
Dec. 20, 2024 (JP) 2024-225669

(51) Int. Cl. G02B 1/16

(52) U.S. Cl. CPC G02B 1/16

(57) ABSTRACT

An optical film disposed on a substrate and comprising one layer or a plurality of layers. At least one layer of the optical film contains metal oxide and metal oxynitride. 80.0%≤[O]/([O]+[N])≤99.0% is satisfied, where [O] represents oxygen atom content in the at least one layer in at %, and [N] represents nitrogen atom content in the at least one layer in at %.

### BACKGROUND

Field of the Technology

The present disclosure relates to an optical film, an optical element, and an optical device.

### Description of the Related Art

In an optical element such as a lens or an optical filter used in an optical device such as a camera, a smartphone, or an exposure apparatus, a substrate is coated by an optical film to improve the optical performance. The optical film coating the substrate is a single-layer film or a multilayer film.

For the optical film, a dielectric material having a large band gap is often used to obtain high light transmittance. This kind of optical film is easily electrified by static electricity, therefore debris such as dust and film particles are likely to attach to the surface of the optical element when attaching the optical element to the body of the optical device, and the debris attached to the optical element cannot be removed easily. Therefore, there is a possibility that the performance of the optical device deteriorates. For example, in the case where the optical device is an image pickup device, there is a possibility that the debris is captured in the output image. In addition, there is a possibility that the debris falls between the optical element and the optical device body at the time of manufacture of the optical device, and the assembly precision is affected.

To address this, Japanese Patent Application Laid-Open No. 2006-221142 discloses using a conductive material such as ITO for the optical film.

However, if the conductive material disclosed in Japanese Patent Application Laid-Open No. 2006-221142 is used for an optical film, there is a possibility that the light transmittance deteriorates due to absorption originating from the material such as band gap absorption and free electron absorption, and therefore improvement has been desired.

### SUMMARY

The present disclosure provides a technique advantageous for improving the antistatic property and the optical performance.

According to one aspect of the present disclosure, an optical film disposed on a substrate and comprising one layer or a plurality of layers. At least one layer of the optical film contains metal oxide and metal oxynitride. 80.0%≤[O]/([O]+[N])≤99.0% is satisfied, where [O] represents oxygen atom content in the at least one layer in at %, and [N] represents nitrogen atom content in the at least one layer in at %.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic section view of an optical element according to an embodiment.

FIG. 2 is a schematic diagram illustrating an example of a film forming apparatus according to the embodiment.

FIG. 3A is a schematic view of an exposure apparatus serving as an example of an optical device including the optical element according to the embodiment.

FIG. 3B is a schematic view of a smartphone serving as another example of an optical device including the optical element according to the embodiment.

FIG. 4A is a schematic section view of an optical element according to Examples 1 to 7.

FIG. 4B is a schematic section view of an optical element according to Comparative Examples 1 and 2.

FIG. 5 is a table illustrating experimental results of Examples 1 to 7 and Comparative Examples 1 and 2.

FIG. 6 is a graph illustrating light absorptance with respect to light wavelengths according to Example 1 and Comparative Example 2.

FIG. 7A is a graph illustrating results of time-of-flight secondary ion mass spectrometry according to Example 2 and Comparative Example 1.

FIG. 7B is a graph illustrating results of time-of-flight secondary ion mass spectrometry according to Example 2 and Comparative Example 1.

FIG. 8 is a graph illustrating average light absorptance in a wavelength range of visible light with respect to [O]/([O]+[N]) according to Examples 1 to 7 and Comparative Example 2.

FIG. 9 is a graph illustrating sheet resistance with respect to [O]/([O] +[N]) according to Examples 1 to 7 and Comparative Example 1.

FIG. 10 is a graph illustrating light absorptance in a wavelength range of ultraviolet light with respect to ([O]+[N])/([M]+[O]+[N]) according to Examples 1 to 7 and Comparative Example 2.

FIG. 11 is a graph illustrating light absorptance in a wavelength range of ultraviolet light with respect to ([O]+[N])/([M]+[O]+[N]) according to Examples 1 to 3, 6, and 7.

FIG. 12 is a graph illustrating light absorptance in a wavelength range of ultraviolet light with respect to a bonding ratio [M−ON]/[M−O] according to Examples 1 to 3.

FIG. 13A is a diagram for describing the layer configuration of an optical film according to Example 8.

FIG. 13B is a graph illustrating light transmittance with respect to the light wavelength in an optical element according to Example 8.

FIG. 14A is a diagram illustrating a layer configuration of an optical film according to Example 9.

FIG. 14B is a graph illustrating light transmittance with respect to the light wavelength in the optical element according to Example 9.

### DESCRIPTION OF THE EMBODIMENTS

An embodiment will be described with reference to drawings. To be noted, in the descriptions below and drawings, the same reference signs are given to elements common to a plurality of drawings. Description of the elements given the same reference signs will be omitted appropriately. In addition, “1.0E+08” means “1.0×10⁸”. The same applies to other numerical values.

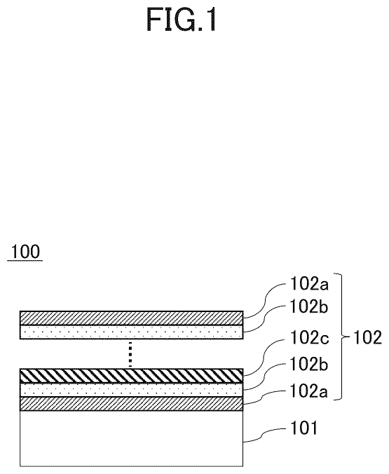

FIG. 1 is a schematic section view of an optical element 100 according to the embodiment. The optical element 100 is an optical element such as a lens, a filter, a mirror, a prism, an image pickup element (image sensor), or a display element (display). Further, the optical element 100 is used for an optical device such as an exposure apparatus, a camera, a replacing lens, or a smartphone.

The optical element 100 includes a substrate 101, and an optical film 102 disposed on the substrate 101. The material of the substrate 101 is, for example, glass or plastics (resin). In addition, the main surface of the substrate 101 may be in various shapes such as a flat surface or a shape including a curved surface in accordance with the use of the optical element 100.

The optical film 102 is constituted by a single layer or a plurality of layers. In the present embodiment, the optical film 102 is constituted by a plurality of layers. At least one layer of the plurality of layers of the optical film 102, one layer 102c in the present embodiment, contains metal oxide and metal oxynitride. To be noted, in the case where the optical film 102 is constituted by a single layer, the single layer is the layer 102c containing metal oxide and metal oxynitride.

In addition, the plurality of layers of the optical film 102 includes one or more low-refractive-index layers 102a and one or more high-refractive-index layers 102b. The low-refractive-index layer 102a is a layer having a lower refractive index than the high-refractive-index layer 102b. In other words, the high-refractive-index layer 102b is a layer having a higher refractive index than the low-refractive-index layer 102a. To be noted, the layer 102c may be a high-refractive-index layer, a low-refractive-index layer, or a layer different from the low-refractive-index layer and the high-refractive-index layer. The layer 102c may be the surface layer of the optical film 102 serving as the surface of the optical element 100, an inner layer of the optical film 102, or a layer in contact with the substrate 101. In the example of FIG. 1, the layer 102c is an inner layer of the optical film 102.

The layer 102c may be at least one of a plurality of high-refractive-index layers 102b. That is, part or all of the plurality of high-refractive-index layers 102b may be the layer 102c. In the case where the optical film 102 is constituted by a single layer, the layer is the layer 102c, and the layer 102c may be a high-refractive-index layer 102b.

To develop an antistatic property in the optical film 102 including the layer 102c containing metal oxide and metal oxynitride, the surface resistivity (that is, sheet resistance) of the optical film 102 including the layer 102c can be set to be low. The amount of generation of debris differs depending on the environment, and the amount of generation of debris is larger in a typical environment than a clean room environment. Therefore, in the case where the optical element 100 is used in a typical environment, a lower resistance value is required for the sheet resistance of the optical film 102 than in the case where the optical element 100 is used in a clean room environment. Therefore, in the case where the optical element 100 is used in a clean room environment, the sheet resistance of the optical film 102 can be 1.0×10¹³ Ω/□ or lower. In the case where the optical element 100 is used in a typical environment, the sheet resistance of the optical film 102 can be 1.0×10¹¹ Ω/□ or lower. To be noted, in the case where the sheet resistance of the optical film 102 is 1.0×10¹¹ Ω/□ or lower, the optical element 100 can be also used in a clean room environment. In addition, the use environment of the optical element 100 is, for example, an environment in which an optical device is manufactured.

As described above, as a result of the sheet resistance of the optical film 102 including the layer 102c containing metal oxide and metal oxynitride being low, an antistatic property is developed in the optical film 102, and in the optical element 100 including the optical film 102 configured in this manner, debris can be easily removed from the optical element 100 by a lens blower or the like even in the case where debris is attached to the surface of the optical element 100.

In addition, to enhance the optical performance of the optical element 100, the light absorptance in the layer 102c containing metal oxide and metal oxynitride, particularly light absorptance for a wavelength of visible light can be set to be low.

In the case where use of the optical element 100 in a wavelength range of visible light is assumed, the average light absorptance in the wavelength range from 400 nm to 800 nm in the layer 102c can be 3.0% or lower. In addition, in the case where a higher optical performance is required for the optical element 100, the average light absorptance in the wavelength range from 400 nm to 800 nm in the layer 102c can be 1.0% or lower.

Further, in the case where use of the optical element 100 in a wavelength range of ultraviolet light is assumed, the light absorptance for the wavelength of 365 nm in the layer 102c can be 1.0% or lower. In addition, in the case where a higher optical performance is required for the optical element 100, the light absorptance for the wavelength of 365 nm in the layer 102c can be 0.3% or lower. In addition, in the case where an even higher optical performance is required for the optical element 100, the light absorptance for the wavelength of 365 nm in the layer 102c can be 0.1% or lower.

Further, in the case where use of the optical element 100 in a wavelength range of infrared light is assumed, the light absorptance for a wavelength of 1000 nm in the layer 102c can be 1.0% or lower.

In the case of using the layer 102c containing metal oxide and metal oxynitride as a high-refractive-index layer, the refractive index for a wavelength of 550 nm can be 2.0 or higher. In this case, the layer 102c can contain at least one metal element from Ta, Ti, Zr, V, Nb, and Cr.

In the case where the optical film 102 is a multilayer film, examples of the material of the low-refractive-index layer 102a include aluminum oxide (Al₂O₃), silicon oxide (SiO₂), and magnesium fluoride (MgF₂), but the material is not limited to these. In addition, the low-refractive-index layer 102a may contain one of these materials as a main component, or may contain a mixture including at least two of these materials.

In addition, in the case where the optical film 102 is a multilayer film, examples of the material of the high-refractive-index layer 102b include tantalum oxide (Ta₂O₅), titanium oxide (TiO₂), and niobium oxide (Nb₂O₅), but the material is not limited to these. In addition, the high-refractive-index layer 102b may contain one of these materials as a main component, or may contain a mixture including at least two of these materials.

In addition, in the case where the optical film 102 is a multilayer film, the plurality of low-refractive-index layers 102a of the optical film 102 may be all formed from the same material, but the configuration is not limited to this. Similarly, the plurality of high-refractive-index layers 102b of the optical film 102 may be all formed from the same material, but the configuration is not limited to this. For example, in the plurality of low-refractive-index layers 102a, some layers may be formed from a different material than the other layers, as in a case where some layers are silicon oxide (SiO₂) layers and the other layers are magnesium fluoride (MgF₂) layers.

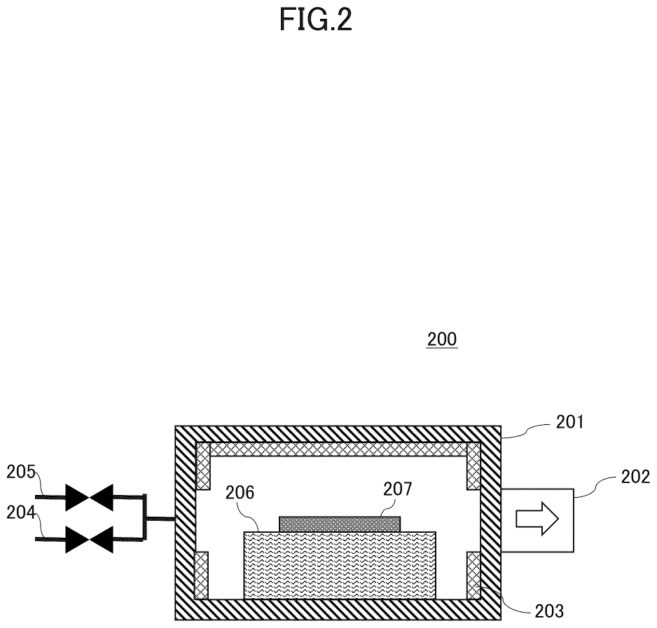

FIG. 2 is a schematic diagram illustrating an example of a film forming apparatus 200 used for forming the layer 102c containing metal oxide and metal oxynitride according to the embodiment. In the formation of the layer 102c of the present embodiment, atomic layer deposition (ALD) can be used, but the method is not limited to this. The method for forming the layer 102c may be, for example, physical vapor deposition such as sputtering, or chemical vapor deposition such as plasma CVD different from ALD.

ALD is a film formation method performed in vacuum. ALD is a film formation method in which a cycle consisting of four steps including a step of introducing an organic metal gas called precursor, a step of purging the precursor, a step of introducing a reactive gas, and a step of purging the reactive gas is repeated a plurality of times to form a film.

The film forming apparatus 200 includes a reaction chamber 201, an exhausting pump 202, a heating mechanism 203, an introduction port 204 for a precursor and an inert gas, and an introduction port 205 for a reactive gas and an inert gas. A substrate holding stage 206 that can be heated is disposed in the reaction chamber 201. A substrate 207 is placed on the substrate holding stage 206, and thus the substrate 207 is held by the substrate holding stage 206. A film (layer) is formed on the substrate 207 held by the substrate holding stage 206.

A case where the metal oxide is tantalum oxide (Ta₂O₅) and the metal oxynitride is tantalum oxynitride (TaON) will be described as an example.

Tris(ethylmethylamido)(tert-butylimido)tantalum(V) is used as the precursor, and H₂O is used as the reactive gas (oxidizing agent).

In addition, in the diffusion step of each of the raw material gas and the reactive gas, a nitrogen gas is introduced as a carrier gas to efficiently diffuse the gas. Also in the purging step, a nitrogen gas is introduced as a carrier gas to efficiently discharge a remaining gas. The environmental temperature in the reaction chamber 201 is set to a low temperature in a range from 70° C. to 150° C. In each cycle, for the precursor, the supply time is set to 1 s, the diffusion time is set to 5 s, and the purging time is set to 10 s. For the oxidizing agent, the supply time is set to 0.1 s, the diffusion time is set to 5 s, and the purging time is set to 10 s. In the case of forming the layer 102c in the conditions described above, the film thickness growth per cycle is about 0.1 nm. To be noted, the number of cycles may be determined in accordance with the target film thickness.

In the present embodiment, as a result of the precursor including nitrogen atoms and setting the environmental temperature in the reaction chamber 201 to a low temperature around 100° C., the layer 102c that is a mixture layer containing metal oxide and metal oxynitride can be formed.

In chemical vapor deposition, film formation is often performed by setting the environmental temperature in the reaction chamber 201 to a high temperature of 300° C. or higher to stabilize the chemical composition of the product. However, according to the present embodiment, the layer 102c that is a mixture layer containing metal oxide and metal oxynitride can be manufactured by setting the environmental temperature in the reaction chamber 201 to a low temperature around 100° C.

In the case where the layer 102c is formed by ALD in a low-temperature environment as described above, sometimes a desired chemical composition cannot be obtained. In such a case, to stably obtain a desired chemical composition, for example, post-processing to radiate light onto the layer 102c for 1 hour or longer from a light source having a bright line at a wavelength of 365 nm is performed after film formation.

To be noted, the method for the post-processing is not limited to the method described above, but in the case of performing post-processing by light irradiation, if a halogen lamp or the like whose bright line is in a wavelength range of visible light is used, change in the chemical composition of the product is small even after the light irradiation because the energy of the light is too low. Therefore, in the post-processing, light radiation onto the layer 102c is performed by using a light source having a bright line in a wavelength range of ultraviolet light whose light energy is higher than in the wavelength range of visible light.

The reason why a desired chemical composition can be obtained stably as a result of irradiating the layer 102c with ultraviolet light is not clear, but is assumed to be because metal oxynitride (for example, TaON) and metal oxynitride carbide (for example, TaONC) generated in the layer 102c when the layer 102c is formed in a low-temperature environment act as a catalyst, thus unreacted components such as a residual raw material and residual moisture are activated in response to irradiation of the layer 102c with light having a bright line in a wavelength range of ultraviolet light, and the chemical reaction is promoted.

In addition, as the post-processing, instead of light irradiation, a desired chemical composition can be also obtained by annealing, but in the case of post-processing by annealing, there is a condition that oxygen or nitrogen is likely to be defected depending on the atmosphere of the annealing environment, heating time, and heating temperature. Therefore, in the present embodiment, the post-processing is performed by the method described above.

To be noted, the precursor or the reactive gas may be changed appropriately in accordance with an aimed material, and for example, in the case of setting the metal element included in the metal oxide and metal oxynitride to Zr instead of Ta, tetrakis(ethylmethylamido)zirconium(IV) or the like is used as the precursor, and in the case of setting the metal element to Hf, tetrakis(ethylmethylamido)hafnium(IV) or the like may be used as the precursor. In addition, as the reactive gas, O₃, H₂O₂, or the like may be used instead of H₂O, and a nitriding agent such as NH₃ may be used in addition to the oxidizing agent.

To be noted, although an example of the formation condition of the layer 102c has been described, the formation condition is not limited to this. For example, the film formation may be performed by changing, from the condition described above, the gas material to be used, the time for introducing the gas or the temperature, or the film formation may be performed by using plasma to promote the reaction.

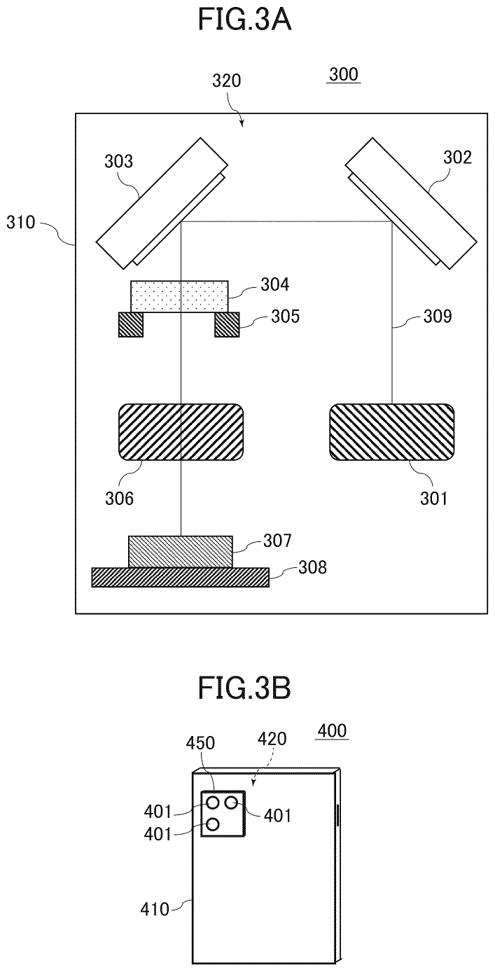

FIG. 3A is a schematic view of an exposure apparatus 300 serving as an example of an optical device including the optical element 100 according to the embodiment. The exposure apparatus 300 includes a casing 310, and an apparatus body 320. At least part of the apparatus body 320 is covered by the casing 310. The apparatus body 320 includes a light source 301, mirrors 302 and 303 constituting an irradiation optical system, a reticle stage 305 mounting a reticle 304, a projection optical system 306 that projects a pattern of the reticle 304, and a stage 308 holding the substrate 307.

A photoresist is applied on the substrate 307, and the photoresist is exposed by exposure light 309. The substrate 307 may be a semiconductor wafer, or a glass substrate for a flat panel display (FPD). The exposure light of the exposure apparatus 300 is typically ultraviolet light. The wavelength of the exposure light is, for example, about 365 nm, but is not limited to this.

The optical element 100 illustrated in FIG. 1 can be employed for, for example, mirrors 302 and 303. In this case, the material of the substrate 101 of the optical element 100 can be glass. To be noted, the optical element 100 may be employed for a lens of the projection optical system 306.

FIG. 3B is a schematic view of a smartphone 400 serving as another example of an optical device including the optical element 100 according to the embodiment. The smartphone 400 includes a casing 410 and a device body 420. At least part of the device body 420 is covered by the casing 410.

The device body 420 includes a camera array module 450. The camera array module 450 includes a plurality of lens units 401 and a plurality of unillustrated image sensors that respectively receive light having passed through the plurality of lens units 401. The plurality of lens units 401 are each disposed on the light receiving surface side of the corresponding one of the plurality of image sensors. The optical element 100 can be employed for at least one lens in a plurality of lenses included in at least one of the plurality of lens units 401. In this case, the material of the substrate 101 of the optical element 100 can be plastics.

To be noted, the optical element 100 is applicable to various optical devices such as a camera, a replacing lens unit of the camera, a projector, and a photosensor, in addition to the optical devices described above.

### EXAMPLES

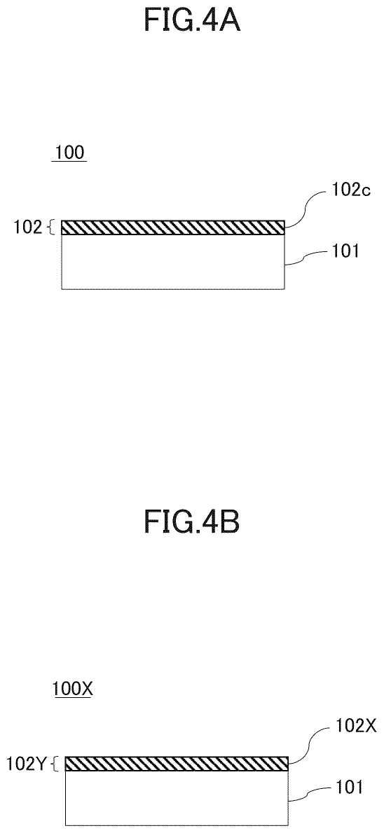

Examples 1 to 7 and Comparative Examples 1 and 2 will be described below. FIG. 4A is a schematic section view of the optical element 100 according to Examples 1 to 7, and FIG. 4B is a schematic section view of an optical element 100X according to Comparative Examples 1 and 2. The optical element 100 of Examples 1 to 7 includes the substrate 101 and the optical film 102. The optical film 102 is constituted by the layer 102c that is a single layer. The optical element 100X of Comparative Examples 1 and 2 includes the substrate 101 and an optical film 102Y. The optical film 102Y is constituted by a layer 102X that is a single layer.

In the description below, the metal atom content (concentration) in the layer 102c or 102X will be denoted by [M] at %, the oxygen atom content (concentration) in the layer 102c or 102X will be denoted by [O] at %, the nitrogen atom content (concentration) in the layer 102c or 102X will be denoted by [N] at %, the hydrogen atom content (concentration) in the layer 102c or 102X will be denoted by [H] at %, the carbon atom content (concentration) in the layer 102c or 102X will be denoted by [C] at %, and the argon atom content (concentration) in the layer 102c or 102X will be denoted by [Ar] at %. Here, “at %” stands for “atomic percentage”, and indicates the percentage of the number of specific atoms with respect to the total atom number in a target.

The chemical composition of the layer 102c containing metal oxide and metal oxynitride can be evaluated by, for example, Rutherford back scattering spectrometry (RBS) by radiating a high-energy ion beam in the order of MeV onto the layer 102c. To be noted, the hydrogen atom content [H] at % can be evaluated by hydrogen forward scattering spectrometry (HFS). The nitrogen atom content [N] at % and the carbon atom content [C] at % that are contents of light elements can be also evaluated by RBS, and can be evaluated with high precision by using nuclear reaction analysis (NRA). Therefore, in the examples, the chemical composition was evaluated by using RBS, HFS, and NRA in combination.

In addition, for the layer 102c containing metal oxide and metal oxynitride, for example, a bonding ratio with the metal oxide and the metal oxynitride in a molecular state can be evaluated by measuring the ionic strength at a mass number of interest, for example, the ionic strength near a mass number of 442 in the case of Ta₂O₅ or the ionic strength near a mass number of 211 in the case of TaON, by using, for example, time-of-flight secondary ion mass spectrometry (ToF-SIMS).

In the present examples, the bonding ratio [M−ON]/[M−O] was evaluated by using TOF-SIMS V manufactured by ION-TOF, in an irradiation area of 200 μm² by using Bi³⁺as the primary ion in a condition of 25 kV and 0.4 pA (pulse width: 10 ns). In addition, to evaluate the bonding ratio in an inner part of the film, the evaluation was performed after etching the film by a required amount in the thickness direction by using a sputtering ion gun. Here, [M−ON] is an ionic strength (signal intensity) originating from the metal oxynitride, and [M−O] is an ionic strength (signal intensity) originating from the metal oxide.

For the layers 102c and 102X, the light transmittance and light reflectance can be measured by, for example, using an ultraviolet-visible-near-infrared (UV-Vis-NIR) spectrometer at a light incident angle of 5° in a wavelength range from 300 nm to 1200 nm. In addition, the light absorptance can be calculated from the measurement results of the light transmittance and the light reflectance by using the following formula (1).

$$A ( \% ) = 100 - T ( \% ) - R ( \% ) \qquad ( 1 )$$

To be noted, A represents the light absorptance indicating the percentage of light absorption with respect to the incident light intensity, T represents the light transmittance indicating the percentage of light transmission with respect to the incident light intensity, and R represents the light reflectance indicating the percentage of light reflection with respect to the incident light intensity.

In the present examples, the light absorptance at a wavelength of 365 nm, the average light absorptance in a wavelength range from 400 nm to 800 nm, and the light absorptance at a wavelength of 1000 nm were each calculated.

For the layers 102c and 102X, the refractive index and the film thickness can be calculated on the basis of the results of measured light reflectance by performing analysis by using optical thin film analysis/designing software Film Wizard TM available from Scientific Computing International. In the present examples, a value at a wavelength of 550 nm was calculated as the refractive index.

For the layers 102c and 102X, the surface resistivity, that is, the sheet resistance of the optical films 102 and 102Y can be evaluated by, for example, using a resistivity meter by pressing double ring electrodes onto the optical film 102 or 102Y and applying a voltage in a range from 10 V to 1000 V between the double ring electrodes. To be noted, in Hiresta UP (MCP-HT450, manufactured by Mitsubishi Chemical) used for the resistivity measurement in the present examples, 1.0×10¹⁴ Ω/□ and higher was out of the measurement range, and thus a sample of a high resistance equal to or higher than 1.0×10¹⁴ Ω/□ could not be evaluated.

### Example 1

In Example 1, the metal oxide was Ta₂O₅, and the metal oxynitride was TaON. In Example 1, the layer 102c that was a mixture layer of Ta₂O₅ and TaON was formed on the substrate 101 of quartz to a thickness of about 100 nm by repeating a cycle ALD 1000 times in the conditions described in the embodiment. The environmental temperature in the reaction chamber 201 was set to 90° C. After the film formation, the layer 102c was irradiated with light from a light source having a bright line at a wavelength of 365 nm for 10 hours as post-processing.

The chemical composition of the layer 102c that was a mixture layer of Ta₂O₅ and TaON manufactured in Example 1 was evaluated by RBS, NRA, and HFS. As a result of the evaluation, the tantalum atom content [M] was 19.5 at %, the oxygen atom content [O] was 60.2 at %, the nitrogen atom content [N] was 2.1 at %, the carbon atom content [C] was 2.6 at %, the hydrogen atom content [H] was 15.6 at %, and the argon atom content [Ar] was 0.0 at %. That is, [O]/([O]+[N]) was 96.6%, and ([O]+[N])/([M]+[O]+[N]) was 76.2%.

In addition, the bonding ratio with Ta₂O₅ and with TaON was evaluated by ToF-SIMS, and the result was [M−ON]/[M−O]=3.7%.

In addition, the light absorptance at a wavelength of 365 nm was 0.03%, the average light absorptance in a wavelength range from 400 nm to 800 nm was 0.00%, and the light absorptance at a wavelength of 1000 nm was 0.01%. That is, extremely good light transmittance was obtained for each of the wavelength range of ultraviolet light, the wavelength range of visible light, and the wavelength range of infrared light.

In addition, the refractive index at a wavelength of 550 nm was 2.01. The layer 102c of Example 1 had a refractive index of 2.0 or higher for the wavelength of 550 nm. Therefore, the layer 102c was usable as a high-refractive-index layer.

Further, the sheet resistance was 5.6×10¹² Ω/□. Since the sheet resistance was 1.0×10¹³ Ω/□ or lower, the optical element 100 had a good antistatic property, and in the case where the optical element 100 was used in a clean room environment, debris attached to the optical element 100 could be easily removed by a lens blower.

### Example 2

In Example 2, the metal oxide was Ta₂O₅, and the metal oxynitride was TaON. In Example 2, the layer 102c that was a mixture layer of Ta₂O₅ and TaON was formed on the substrate 101 of quartz to a thickness of about 100 nm by repeating a cycle of ALD 1000 times in the conditions described in the embodiment. The environmental temperature in the reaction chamber 201 was set to 70° C. After the film formation, the layer 102c was irradiated with light from a light source having a bright line at a wavelength of 365 nm for 10 hours as post-processing.

The chemical composition of the layer 102c that was a mixture layer of Ta₂O₅ and TaON manufactured in Example 2 was evaluated by RBS, NRA, and HFS. As a result of the evaluation, the tantalum atom content [M] was 19.3 at %, the oxygen atom content [O] was 55.9 at %, the nitrogen atom content [N] was 2.7 at %, the carbon atom content [C] was 4.7 at %, the hydrogen atom content [H] was 17.3 at %, and the argon atom content [Ar] was 0.0 at %. That is, [O]/([O]+[N]) was 95.3%, and ([O]+[N])/([M]+[O]+[N]) was 75.2%.

In addition, the bonding ratio with Ta₂O₅ and with TaON was evaluated by ToF-SIMS, and the result was [M−ON]/[M−O]=15.9%.

In addition, the light absorptance at a wavelength of 365 nm was 0.16%, the average light absorptance in a wavelength range from 400 nm to 800 nm was 0.03%, and the light absorptance at a wavelength of 1000 nm was 0.01%. That is, extremely good light transmittance was obtained for each of the wavelength range of ultraviolet light, the wavelength range of visible light, and the wavelength range of infrared light.

In addition, the refractive index at a wavelength of 550 nm was 2.02. That is, the layer 102c of Example 2 had a refractive index of 2.0 or higher for the wavelength of 550 nm. Therefore, the layer 102c was usable as a high-refractive-index layer.

Further, the sheet resistance was 2.9×10¹⁰ Ω/□. Since the sheet resistance was 1.0×10¹¹ Ω/□ or lower, the optical element 100 had an extremely good antistatic property, and debris attached to the optical element 100 could be easily removed by a lens blower in either of the case where the optical element 100 was used in a typical environment and the case where the optical element 100 was used in a clean room environment.

### Example 3

In Example 3, the metal oxide was Ta₂O₅, and the metal oxynitride was TaON. In Example 3, the layer 102c that was a mixture layer of Ta₂O₅ and TaON was formed on the substrate 101 of quartz to a thickness of about 100 nm by repeating a cycle of ALD 1000 times in the conditions described in the embodiment. The environmental temperature in the reaction chamber 201 was set to 150° C. After the film formation, the layer 102c was irradiated with light from a light source having a bright line at a wavelength of 365 nm for 10 hours as post-processing.

The chemical composition of the layer 102c that was a mixture layer of Ta₂O₅ and TaON manufactured in Example 3 was evaluated by RBS, NRA, and HFS. As a result of the evaluation, the tantalum atom content [M] was 23.4 at %, the oxygen atom content [O] was 61.7 at %, the nitrogen atom content [N] was 1.0 at %, the carbon atom content [C] was 3.5 at %, the hydrogen atom content [H] was 10.4 at %, and the argon atom content [Ar] was 0.0 at %. That is, [O]/([O]+[N]) was 98.4%, and ([O]+[N])/([M]+[O]+[N]) was 72.8%.

In addition, the bonding ratio with Ta₂O₅ and with TaON was evaluated by ToF-SIMS, and the result was [M−ON]/[M−O]=5.9%.

In addition, the light absorptance at a wavelength of 365 nm was 0.62%, the average light absorptance in a wavelength range from 400 nm to 800 nm was 0.93%, and the light absorptance at a wavelength of 1000 nm was 0.01%. That is, good light transmittance was obtained for each of the wavelength range of ultraviolet light, the wavelength range of visible light, and the wavelength range of infrared light.

In addition, the refractive index at a wavelength of 550 nm was 2.07. That is, the layer 102c of Example 3 had a refractive index of 2.0 or higher for the wavelength of 550 nm. Therefore, the layer 102c was usable as a high-refractive-index layer.

Further, the sheet resistance was 2.5×10¹² Ω/□. Since the sheet resistance was 1.0×10¹³ Ω/□ or lower, the optical element 100 had a good antistatic property, and debris attached to the optical element 100 could be easily removed by a lens blower in the case where the optical element 100 was used in a clean room environment.

### Example 4

In Example 4, the metal oxide was Ta₂O₅, and the metal oxynitride was TaON. In Example 4, the layer 102c that was a mixture layer of Ta₂O₅ and TaON was formed on the substrate 101 of quartz to a thickness of about 100 nm by a reactive sputtering method different from the method described in the embodiment. The argon gas flow rate was set to 150 sccm, the oxygen gas flow rate was set to 30 sccm, the nitrogen gas flow rate was set to 40 sccm, and the hydrogen gas flow rate was set to 20 sccm. A 9-inch metal tantalum (purity: 99.9 wt % or higher) was set as the target material of the sputtering, and film formation was performed by applying a power of 10 W/cm². The distance between the substrate 101 and the target material was set to 100 mm. After the film formation, the layer 102c was irradiated with light from a light source having a bright line at a wavelength of 365 nm for 10 hours as post-processing.

The chemical composition of the layer 102c that was a mixture layer of Ta₂O₅ and TaON manufactured in Example 4 was evaluated by RBS, NRA, and HFS. As a result of the evaluation, the tantalum atom content [M] was 26.6 at %, the oxygen atom content [O] was 62.0 at %, the nitrogen atom content [N] was 4.3 at %, the carbon atom content [C] was 0.0 at %, the hydrogen atom content [H] was 5.8 at %, and the argon atom content [Ar] was 1.3 at %. That is, [O]/([O]+[N]) was 93.5%, and ([O]+[N])/([M]+[O]+[N]) was 71.3%.

In addition, the light absorptance at a wavelength of 365 nm was 9.77%, the average light absorptance in a wavelength range from 400 nm to 800 nm was 0.93%, and the light absorptance at a wavelength of 1000 nm was 0.01%. That is, extremely good light transmittance was obtained for each of the wavelength range of visible light and the wavelength range of infrared light.

In addition, the refractive index at a wavelength of 550 nm was 2.17. That is, the layer 102c of Example 4 had a refractive index of 2.0 or higher for the wavelength of 550 nm. Therefore, the layer 102c was usable as a high-refractive-index layer.

Further, the sheet resistance was 8.6×10⁹ Ω/□. Since the sheet resistance was 1.0×10¹¹ Ω/□ or lower, the optical element 100 had an extremely good antistatic property, and debris attached to the optical element 100 could be easily removed by a lens blower in either of the case where the optical element 100 was used in a typical environment and the case where the optical element 100 was used in a clean room environment.

### Example 5

In Example 5, the metal oxide was Ta₂O₅, and the metal oxynitride was TaON. In Example 5, the layer 102c that was a mixture layer of Ta₂O₅ and TaON was formed on the substrate 101 of quartz to a thickness of about 100 nm by a reactive sputtering method similarly to Example 4. However, the nitrogen gas flow rate was set to 50 sccm. After the film formation, the layer 102c was irradiated with light from a light source having a bright line at a wavelength of 365 nm for 10 hours as post-processing.

The chemical composition of the layer 102c that was a mixture layer of Ta₂O₅ and TaON manufactured in Example 5 was evaluated by RBS, NRA, and HFS. As a result of the evaluation, the tantalum atom content [M] was 27.3 at %, the oxygen atom content [O] was 53.5 at %, the nitrogen atom content [N] was 12.4 at %, the carbon atom content [C] was 0.0 at %, the hydrogen atom content [H] was 5.5 at %, and the argon atom content [Ar] was 1.2 at %. That is, [O]/([O]+[N]) was 81.1%, and ([O]+[N])/([M]+[O]+[N]) was 70.7%.

In addition, the light absorptance at a wavelength of 365 nm was 27.9%, the average light absorptance in a wavelength range from 400 nm to 800 nm was 2.64%, and the light absorptance at a wavelength of 1000 nm was 0.01%. That is, good light transmittance was obtained for each of the wavelength range of visible light and the wavelength range of infrared light.

In addition, the refractive index at a wavelength of 550 nm was 2.21. The layer 102c of Example 5 had a refractive index of 2.0 or higher for the wavelength of 550 nm. Therefore, the layer 102c was usable as a high-refractive-index layer.

Further, the sheet resistance was 6.0×10⁹ Ω/□. Since the sheet resistance was 1.0×10¹¹ Ω/□ or lower, the optical element 100 had an extremely good antistatic property, and debris attached to the optical element 100 could be easily removed by a lens blower in either of the case where the optical element 100 was used in a typical environment and the case where the optical element 100 was used in a clean room environment.

### Example 6

In Example 6, the metal oxide was HfO₂, and the metal oxynitride was HfON. In Example 6, the layer 102c that was a mixture layer of HfO₂ and HfON was formed on the substrate 101 of quartz to a thickness of about 100 nm by repeating a cycle of ALD 1000 times in the conditions described in the embodiment. Tetrakis(ethylmethylamido)hafnium(IV) was used as the precursor, and the environmental temperature in the reaction chamber 201 was set to 150° C. After the film formation, the layer 102c was irradiated with light from a light source having a bright line at a wavelength of 365 nm for 10 hours as post-processing.

The chemical composition of the layer 102c that was a mixture layer of HfO₂ and HfON manufactured in Example 6 was evaluated by RBS, NRA, and HFS. As a result of the evaluation, the hafnium atom content [M] was 22.4 at %, the oxygen atom content [O] was 65.6 at %, the nitrogen atom content [N] was 1.7 at %, the carbon atom content [C] was 2.1 at %, the hydrogen atom content [H] was 8.2 at %, and the argon atom content [Ar] was 0.0 at %. That is, [O]/([O]+[N]) was 97.4%, and ([O]+[N])/([M]+[O]+[N]) was 75.0%.

In addition, the light absorptance at a wavelength of 365 nm was 0.20%, the average light absorptance in a wavelength range from 400 nm to 800 nm was 0.08%, and the light absorptance at a wavelength of 1000 nm was 0.14%. That is, extremely good light transmittance was obtained for each of the wavelength range of ultraviolet light, the wavelength range of visible light, and the wavelength range of infrared light.

In addition, the refractive index at a wavelength of 550 nm was 1.94.

Further, the sheet resistance was 1.2×10¹⁰ Ω/□. Since the sheet resistance was 1.0×10¹¹ Ω/□ or lower, the optical element 100 had an extremely good antistatic property, and debris attached to the optical element 100 could be easily removed by a lens blower in either of the case where the optical element 100 was used in a typical environment and the case where the optical element 100 was used in a clean room environment.

### Example 7

In Example 7, the metal oxide was ZrO₂, and the metal oxynitride was ZrON. In Example 7, the layer 102c that was a mixture layer of ZrO₂ and ZrON was formed on the substrate 101 of quartz to a thickness of about 100 nm by repeating a cycle of ALD 1000 times in the conditions described in the embodiment. Tetrakis(ethylmethylamido)zirconium(IV) was used as the precursor, and the environmental temperature in the reaction chamber 201 was set to 150° C. After the film formation, the layer 102c was irradiated with light from a light source having a bright line at a wavelength of 365 nm for 10 hours as post-processing.

The chemical composition of the layer 102c that was a mixture layer of ZrO₂ and ZrON manufactured in Example 7 was evaluated by RBS, NRA, and HFS. As a result of the evaluation, the zirconium atom content [M] was 22.7 at %, the oxygen atom content [O] was 66.9 at %, the nitrogen atom content [N] was 1.5 at %, the carbon atom content [C] was 1.4 at %, the hydrogen atom content [H] was 10.9 at %, and the argon atom content [Ar] was 0.0 at %. That is, [O]/([O]+[N]) was 97.8%, and ([O]+[N])/([M]+[O]+[N]) was 75.1%.

In addition, the light absorptance at a wavelength of 365 nm was 0.30%, the average light absorptance in a wavelength range from 400 nm to 800 nm was 0.02%, and the light absorptance at a wavelength of 1000 nm was 0.02%. That is, extremely good light transmittance was obtained for each of the wavelength range of ultraviolet light, the wavelength range of visible light, and the wavelength range of infrared light.

In addition, the refractive index at a wavelength of 550 nm was 2.21. The layer 102c of Example 7 had a refractive index of 2.0 or higher for the wavelength of 550 nm. Therefore, the layer 102c was usable as a high-refractive-index layer.

Further, the sheet resistance was 8.7×10¹⁰ Ω/□. Since the sheet resistance was 1.0×10¹¹ Ω/□ or lower, the optical element 100 had an extremely good antistatic property, and debris attached to the optical element 100 could be easily removed by a lens blower in either of the case where the optical element 100 was used in a typical environment and the case where the optical element 100 was used in a clean room environment.

### Comparative Example 1

In Comparative Example 1, the layer 102X that was a Ta₂O₅ layer was formed on the substrate 101 of quartz to a thickness of about 100 nm by a reactive sputtering method similarly to the method of Example 4. However, the nitrogen gas flow rate was set to 0 sccm. After the film formation, the layer 102X was irradiated with light from a light source having a bright line at a wavelength of 365 nm for 10 hours as post-processing.

The chemical composition of the layer 102X that was a Ta₂O₅ layer manufactured in Comparative Example 1 was evaluated by RBS, NRA, and HFS. As a result of the evaluation, the tantalum atom content [M] was 26.3 at %, the oxygen atom content [O] was 66.5 at %, the nitrogen atom content [N] was 0.0 at %, the carbon atom content [C] was 0.0 at %, the hydrogen atom content [H] was 5.9 at %, and the argon atom content [Ar] was 1.3 at %. That is, [O]/([O]+[N]) was 100%, and ([O]+[N])/([M]+[O]+[N]) was 71.7%. In addition, the refractive index at a wavelength of 550 nm was 2.16.

In addition, the light absorptance at a wavelength of 365 nm was 0.03%, the average light absorptance in a wavelength range from 400 nm to 800 nm was 0.00%, and the light absorptance at a wavelength of 1000 nm was 0.00%. That is, extremely good light transmittance was obtained for each of the wavelength range of ultraviolet light, the wavelength range of visible light, and the wavelength range of infrared light.

Further, the sheet resistance was 1.0×10¹⁴ Ω/□, and a good antistatic property was not obtained by the optical element 100X according to Comparative Example 1.

### Comparative Example 2

In Comparative Example 2, the layer 102X that was a TaON layer was formed on the substrate 101 of quartz to a thickness of about 100 nm by a reactive sputtering method similarly to the method of Example 4. However, the oxygen gas flow rate was set to 20 sccm, and the nitrogen gas flow rate was set to 80 sccm. After the film formation, the layer 102X was irradiated with light from a light source having a bright line at a wavelength of 365 nm for 10 hours as post-processing.

The chemical composition of the layer 102X that was a TaON layer manufactured in Comparative Example 2 was evaluated by RBS, NRA, and HFS. As a result of the evaluation, the tantalum atom content [M] was 28.9 at %, the oxygen atom content [O] was 33.8 at %, the nitrogen atom content [N] was 31.3 at %, the carbon atom content [C] was 0.0 at %, the hydrogen atom content [H] was 4.9 at %, and the argon atom content [Ar] was 1.1 at %. That is, [O]/([O]+[N]) was 51.9%, and ([O]+[N])/([M]+[O]+[N]) was 69.2%. In addition, the refractive index at a wavelength of 550 nm was 2.29.

In Comparative Example 2, the composition ratio between the oxygen atom content [O] and the nitrogen atom content [N] was approximately 1:1, and therefore it was determined that only TaON was generated on the layer 102X.

Further, the sheet resistance was 3.0×10² Ω/□. Since the sheet resistance was 1.0×10¹¹ Ω/□ or lower, the optical element 100X had an extremely good antistatic property.

However, the light absorptance at a wavelength of 365 nm was 69.7%, the average light absorptance in a wavelength range from 400 nm to 800 nm was 6.59%, and the light absorptance at a wavelength of 1000 nm was 0.02%. In the optical element 100X of Comparative Example 2, good light transmittance was obtained for the wavelength range of infrared light, but was not obtained for the wavelength range of ultraviolet light and the wavelength range of visible light.

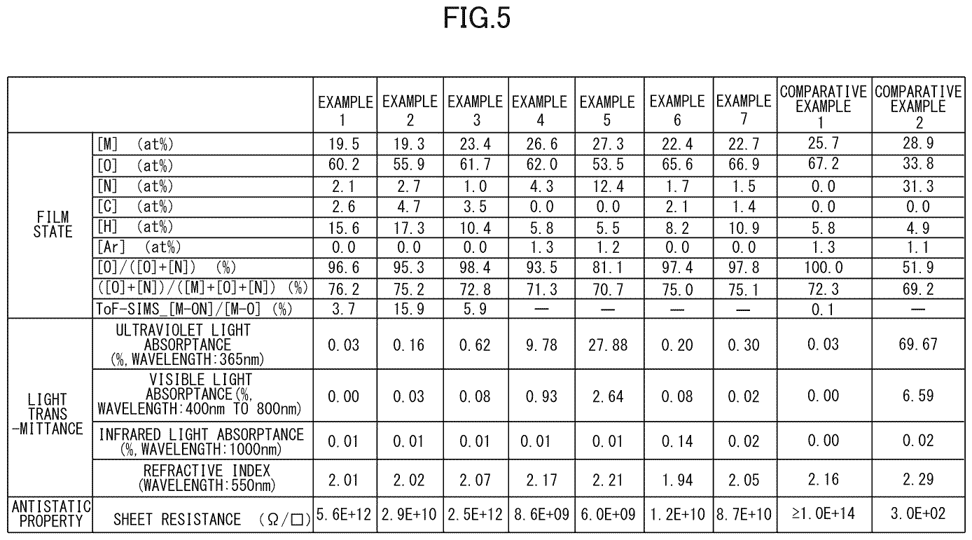

FIG. 5 is a table illustrating experimental results of Examples 1 to 7 and Comparative Examples 1 and 2. In each of the layers 102c of Examples 1 to 7, an antistatic property was obtained, and good light transmittance was obtained in the case of use in the wavelength range of visible light and the wavelength range of infrared light. Specifically, in each of the layers 102c of Examples 1 to 7, the sheet resistance was 1.0×10¹³ Ω/□ or lower, the average light absorptance in the wavelength range from 400 nm to 800 nm was 3.0% or lower, and the light absorptance for the wavelength of 1000 nm was 1.0% or lower.

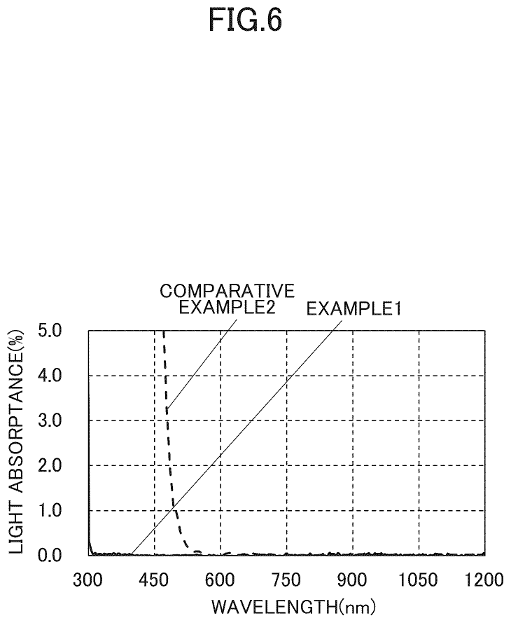

FIG. 6 is a graph illustrating light absorptance with respect to the wavelength of light in Example 1 and Comparative Example 2. As illustrated in FIG. 6, in Example 1, the absorptance for the wavelength of 365 nm and the wavelength range from 400 nm to 800 nm is improved as compared with Comparative Example 2.

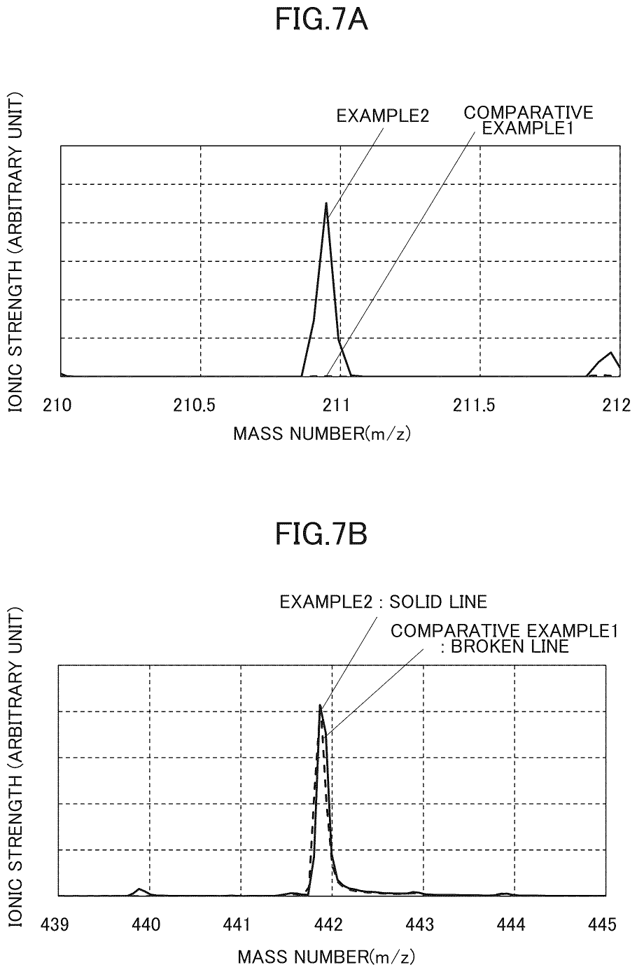

FIGS. 7A and 7B are each a graph illustrating a result of ToF-SIMS analysis according to Example 2 and Comparative Example 1. As illustrated in FIG. 7A, in Example 2, the peak of the ionic strength [M−ON] originating from the metal oxynitride (TaON) appears near the mass number of 211. However, in Comparative Example 1, the peak of the ionic strength [M−ON] originating from the metal oxynitride (TaON) does not appear near the mass number of 211. In contrast, as illustrated in FIG. 7B, the peak of the ionic strength originating from the metal oxide (Ta₂O₅) appears near the mass number of 442 in both Example 2 and Comparative Example 1.

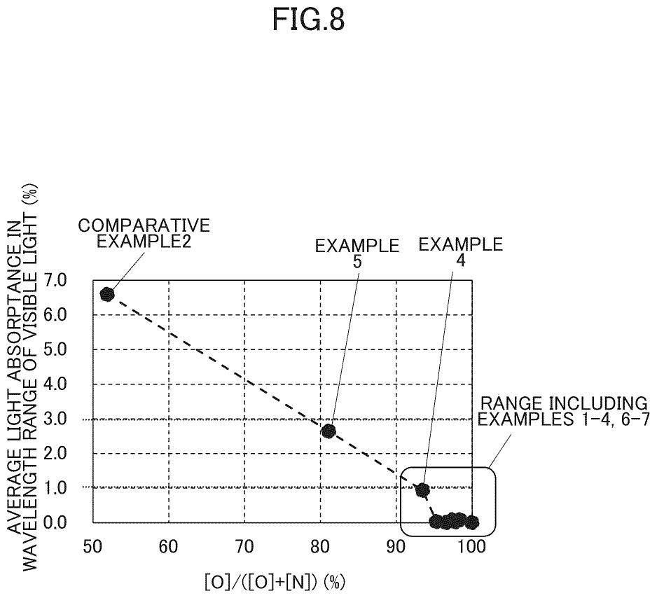

FIG. 8 is a graph illustrating the average light absorptance in the wavelength range of visible light with respect to [O]/([O]+[N]) according to Examples 1 to 7 and Comparative Example 2. In FIG. 8, the experimental results of Examples 1 to 7 and Comparative Example 2 are plotted as black dots, and the black dots are interpolated by straight lines (broken lines).

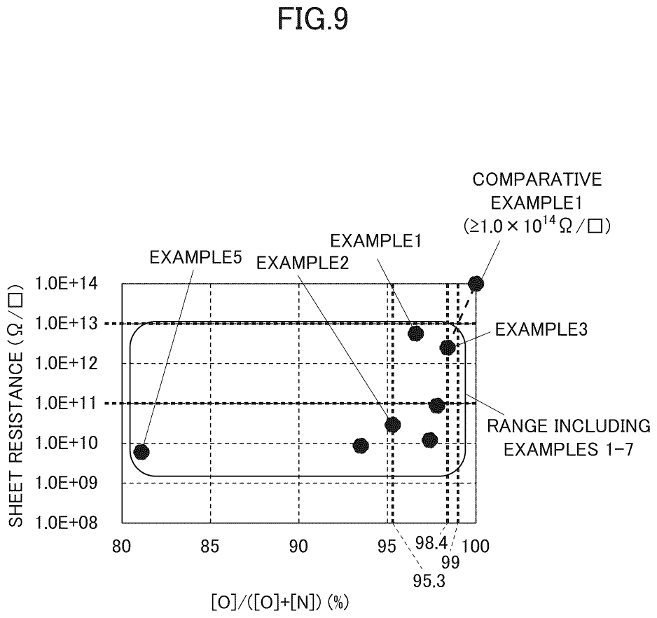

In addition, FIG. 9 is a graph illustrating the sheet resistance with respect to [O]/([O]+[N]) according to Examples 1 to 7 and Comparative Example 1. In Comparative Example 1 in which [O]/([O]+[N]) was 100%, the sheet resistance was 1.0×10¹⁴ Ω/□ or higher, and the antistatic property was low. In FIG. 9, the experimental results of Examples 1 to 7 and Comparative Example 1 are plotted as black dots, and the black dots of Example 3 and Comparative Example 1 are interpolated by straight lines (broken lines).

As can be seen from the interpolation line interpolating a black dot indicating Comparative Example 2 and a black dot indicating Example 5 illustrated in FIG. 8, the average light absorptance in the wavelength range of visible light (wavelength range from 400 nm to 800 nm) where the value of [O]/([O]+[N]) is lower than 80.0% is 3.0%. Therefore, as illustrated in FIG. 8, the average light absorptance in the wavelength range of visible light (wavelength range from 400 nm to 800 nm) is 3.0% or lower as a result of satisfying 80.0%≤[O]/([O]+[N]).

In addition, from the interpolation line interpolating a black dot indicating Comparative Example 1 and a black dot indicating Example 1 illustrated in FIG. 9, the sheet resistance is calculated to be 1.0×10¹³ Ω/□. Therefore, as illustrated in FIG. 9, the sheet resistance is 1.0×10¹³ Ω/□ or lower as a result of satisfying [O]/([O]+[N])≤99.0%.

The reason for the sheet resistance to be 1.0×10¹³ Ω/□ or lower in the range including Examples 1 to 7 is not clear, but it is assumed that the metal oxynitride present in a small amount in the layer 102c containing metal oxide and metal oxynitride serves as a conduction path for a current with a higher priority, and thus the sheet resistance is greatly lowered even with the low nitrogen content satisfying 80.0%≤[O]/([O]+[N])≤99.0%.

As described above, according to the examples, as a result of satisfying 80.0%≤[O]/([O]+[N])≤99.0%, the sheet resistance is 1.0×10¹³ Ω/□ or lower, and the average light absorptance in the wavelength range of visible light (wavelength range from 400 nm to 800 nm) is 3.0% or lower. That is, the antistatic property of the optical film 102 is improved, and the optical performance of the optical film 102 is improved.

In addition, from the experimental results of Examples 1 to 7 illustrated in FIG. 9, it can be seen that as a result of satisfying [O]/([O]+[N])≤98.4%, the sheet resistance is lower than 1.0×10¹³ Ω/□. That is, the antistatic property of the optical film 102 is further improved.

In addition, as illustrated in FIG. 8, from the experimental results of Examples 1 to 4, 6, and 7, it can be seen that as a result of satisfying 93.5%≤[O]/([O]+[N]), the average light absorptance in the wavelength range of visible light (wavelength range from 400 nm to 800 nm) is 1.0% or lower. The reason why the average light absorptance in the wavelength range of visible light is 1.0% or lower is not clear, but it is assumed to be because the influence of band gap absorption originating from the oxynitride is smaller. As described above, as a result of satisfying 93.5%≤[O]/([O]+[N]), the optical performance of the optical film 102 is further improved.

In addition, focusing on the sheet resistance, as illustrated in FIG. 9, in the case of satisfying [O]/([O]+[N])≤95.3%, the sheet resistance is 1.0×10¹¹ Ω/□ or lower. To be noted, the average light absorptance in the wavelength range of visible light (wavelength range from 400 nm to 800 nm) is 3.0% or lower. As a result of this, the antistatic property of the optical film 102 is further improved. For example, debris attached to the surface of the optical element 100 can be easily removed by a blower or the like in either of a typical environment and a clean room environment.

In addition, as a result of detailed examination of the table illustrated in FIG. 5, the present inventor have found out that there is a correlation between the state of the film, the light transmittance, and the antistatic property, by focusing not only on the content of each element but also the percentages of [M], [O], and [N] and the bonding ratio with the metal oxide and the metal oxynitride, for the layer 102c containing metal oxide and metal oxynitride.

Conditions in which excellent light transmittance can be obtained for the wavelength range of ultraviolet light (wavelength of 365 nm) will be further described for the layer 102c containing metal oxide and metal oxynitride.

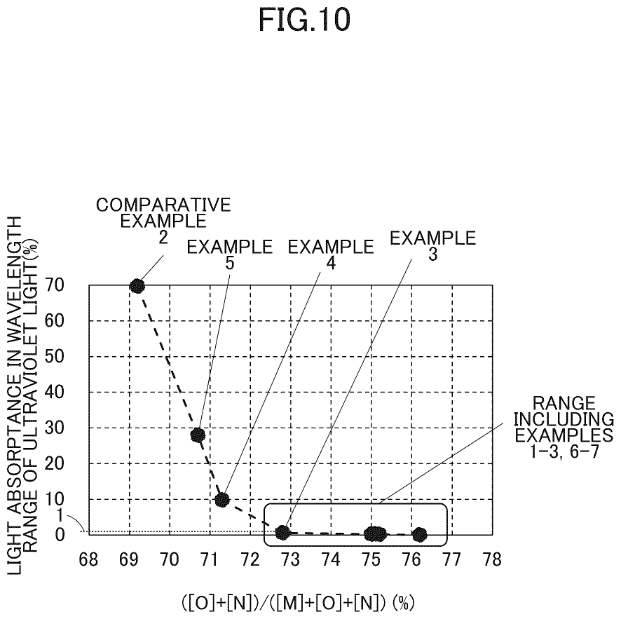

FIG. 10 is a graph illustrating the light absorptance in the wavelength range of ultraviolet light (wavelength of 365 nm) with respect to ([O]+[N])/([M]+[O]+[N]) according to Examples 1 to 7 and Comparative Example 2. In FIG. 10, the experimental results of Examples 1 to 7 and Comparative Example 2 are plotted as black dots, and the plurality of black dots are interpolated by straight lines (broken lines).

As can be seen from FIGS. 5 and 10, the light absorptance in the wavelength range of ultraviolet light (wavelength of 365 nm) was 1.0% or lower in Examples 1 to 3, 6, and 7. As can be seen from the results of Examples 1 to 3, 6, and 7, in the case where 95.3%≤[O]/([O]+[N])≤99.0% and ([O]+[N])/([M]+[O]+[N])≥72.8% are satisfied, the average light absorptance in the wavelength range of visible light is 3.0% or lower, the light absorptance in the wavelength range of ultraviolet light (wavelength of 365 nm) is 1.0% or lower, and the sheet resistance is 1.0×10¹³ Ω/□ or lower. In the case where use of the optical element 100 in the wavelength range of ultraviolet light is assumed, it is assumed that, in addition to removing the influence of band gap absorption originating from the oxynitride, the influence of absorption by bonding defects of oxygen and nitrogen was also reduced by satisfying ([O]+[N])/([M]+[O]+[N])≥72.8%, and thus high light transmittance was obtained in the wavelength range of ultraviolet light. Therefore, the antistatic property of the optical film 102 is improved, and the optical performance (particularly light transmittance for ultraviolet light) of the optical film 102 is further improved.

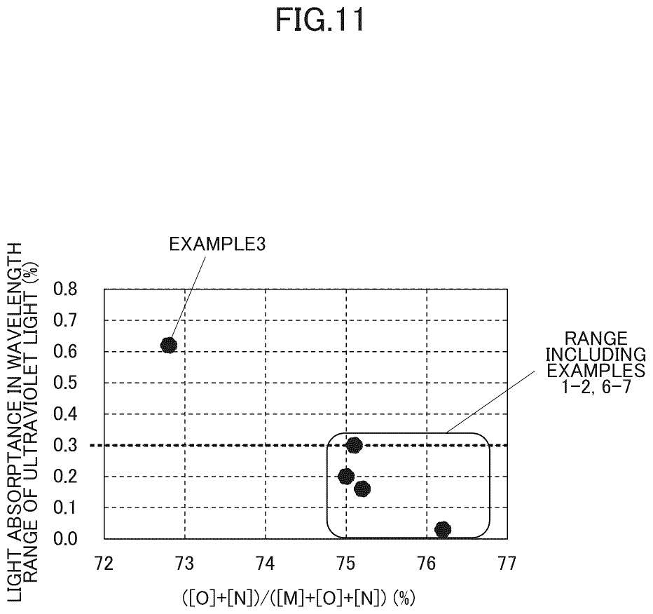

FIG. 11 is a graph illustrating light absorptance in the wavelength range of ultraviolet light (wavelength of 365 nm) with respect to ([O]+[N])/([M]+[O]+[N]) according to Examples 1 to 3, 6, and 7. In FIG. 11, experimental results of Examples 1 to 3, 6, and 7 are plotted as black dots.

As can be seen from FIGS. 5 and 11, the light absorptance in the wavelength range of ultraviolet light (wavelength of 365 nm) was 1% or lower in Examples 1, 2, 6, and 7. As can be seen from the results of Examples 1, 2, 6, and 7, in the case where 95.3%≤[O]/([O]+[N])≤99.0% and ([O]+[N])/([M]+[O]+[N])≥75.0% are satisfied, the average light absorptance in the wavelength range of visible light is 3.0% or lower, the light absorptance in the wavelength range of ultraviolet light (wavelength of 365 nm) is 0.3% or lower, and the sheet resistance is 1.0×10¹³ Ω/□ or lower. Therefore, the antistatic property of the optical film 102 is improved, and the optical performance (particularly light transmittance for ultraviolet light) of the optical film 102 is further improved.

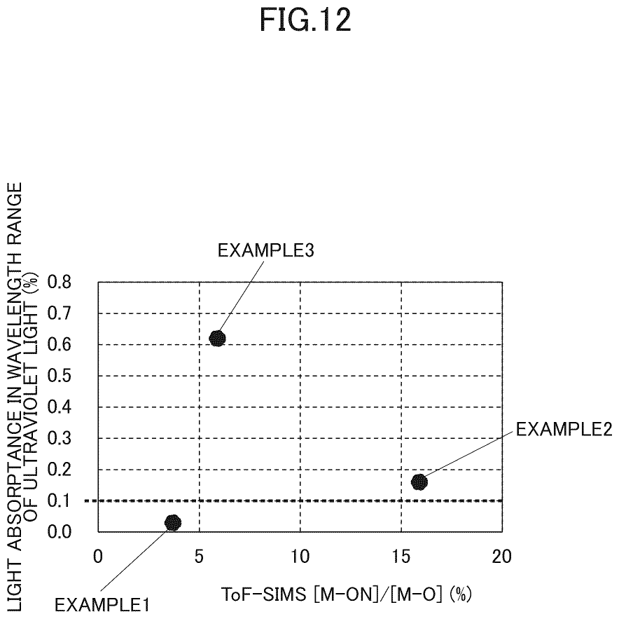

FIG. 12 is a graph illustrating light absorptance in the wavelength range of ultraviolet light (wavelength of 365 nm) with respect to the bonding ratio [M−ON]/[M−O] according to Examples 1 to 3. In FIG. 12, experimental results of Examples 1 to 3 are plotted as black dots.

As can be seen from FIGS. 5 and 12, the light absorptance in the wavelength range of ultraviolet light (wavelength of 365 nm) was 1% or lower in Example 1. As can be seen from the results of Example 1, in the case where 95.3%≤[O]/([O]+[N])≤99.0% and ([O]+[N])/([M]+[O]+[N])≥75.0% are satisfied and the bonding ratio evaluated by ToF-SIMS satisfies [M−ON]/[M−O]≤5.0%, the average light absorptance in the wavelength range of visible light is 3.0% or lower, the light absorptance in the wavelength range of ultraviolet light (wavelength of 365 nm) is 0.1% or lower, and the sheet resistance is 1.0×10¹³ Ω/□ or lower. It is assumed that, the influence of band gap absorption originating from the oxynitride was reduced by satisfying [M−ON]/[M−O]≤5.0%, and thus extremely high light transmittance in which the light absorptance in the wavelength of 365 nm was 0.1% or lower was obtained. Therefore, the antistatic property of the optical film 102 is improved, and the optical performance (particularly light transmittance for ultraviolet light) of the optical film 102 is further improved.

### Example 8

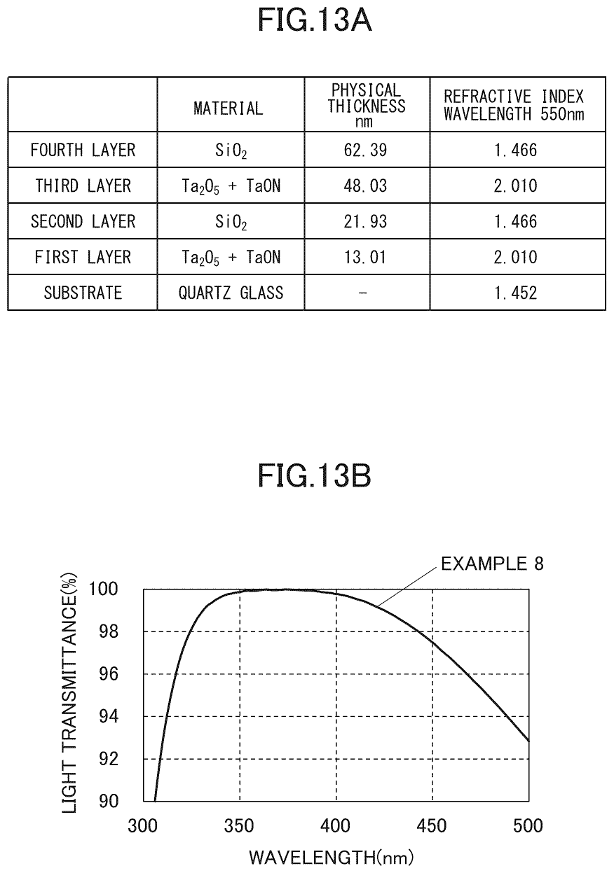

FIG. 13A is a diagram for describing the layer configuration of the optical film 102 according to Example 8. The optical element 100 manufactured in Example 8 is an optical element of a light transmitting type. The optical film 102 is an antireflection film having an antireflection structure. The material of the substrate 101 was quartz glass. The optical film 102 was a multilayer film including a first layer, a second layer, a third layer, and a fourth layer. The first layer, the second layer, the third layer, and the fourth layer were arranged in this order from the substrate 101 toward the surface of the optical element 100. The first layer was a high-refractive-index layer 102b, the second layer was a low-refractive-index layer 102a, the third layer was a high-refractive-index layer 102b, and the fourth layer was a low-refractive-index layer 102a. As described above, in Example 8, the optical film 102 was formed by alternately laminating the high-refractive-index layer 102b and the low-refractive-index layer 102a up to four layers.

In Example 8, as the high-refractive-index layer 102b, the layer 102c that was a mixture layer containing metal oxide (Ta₂O₅) and metal oxynitride (TaON) was formed by using the conditions shown in Example 1. In addition, a layer that was a mixture layer containing silicon oxide (SiO₂) was formed as the low-refractive-index layer 102a. To maximize the transmittance characteristic for the wavelength of 365 nm, the physical thickness of each layer was optimized and the configuration of the optical film 102 was determined. FIG. 13A illustrates the material used for the optical element of Example 8, the physical thickness of each layer, and the refractive index for the wavelength of 550 nm.

The light transmittance of the optical element 100 having the configuration illustrated in FIG. 13A was measured at a light incident angle of 5°. FIG. 13B is a graph illustrating the light transmittance with respect to the wavelength of the light in the optical element 100 according to Example 8. An extremely good result that the light transmittance for the wavelength of 365 nm was 99.9% or higher was obtained, and a good result was obtained also for the antistatic property.

### Example 9

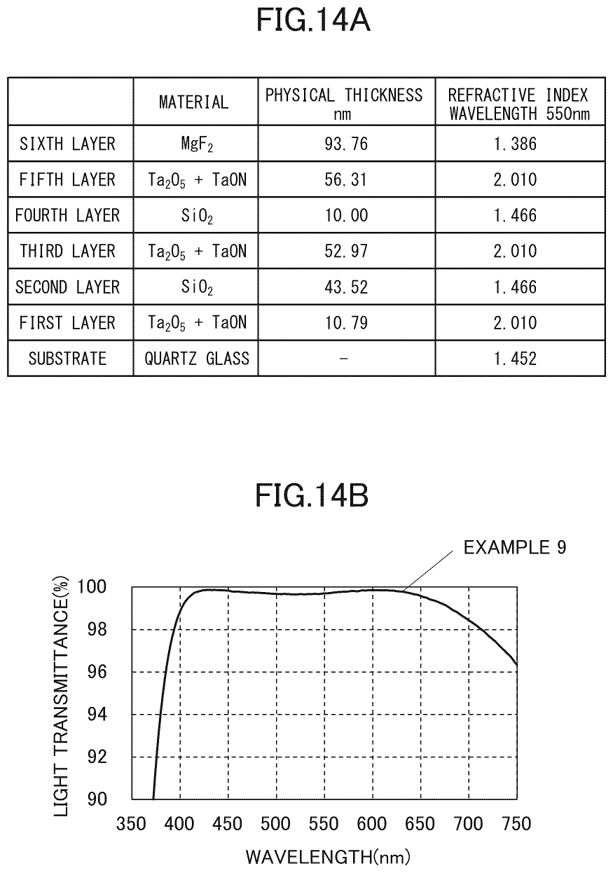

FIG. 14A is a diagram for describing the layer configuration of the optical film 102 according to Example 9. The optical element 100 manufactured in Example 9 is an optical element of a light transmitting type. The optical film 102 is an antireflection film having an antireflection structure. The material of the substrate 101 was quartz glass. The optical film 102 was a multilayer film including a first layer, a second layer, a third layer, a fourth layer, a fifth layer, and a sixth layer. The first layer, the second layer, the third layer, the fourth layer, the fifth layer, and the sixth layer were arranged in this order from the substrate 101 toward the surface of the optical element 100. The first layer was a high-refractive-index layer 102b, the second layer was a low-refractive-index layer 102a, the third layer was a high-refractive-index layer 102b, the fourth layer was a low-refractive-index layer 102a, the fifth layer was a high-refractive-index layer 102b, and the sixth layer was an outermost layer. In Example 9, the optical film 102 was formed by alternately laminating the high-refractive-index layer 102b and the low-refractive-index layer 102a up to five layers and disposing the sixth layer as the outermost layer.

In Example 9, as the high-refractive-index layer 102b, the layer 102c that was a mixture layer containing metal oxide (Ta₂O₅) and metal oxynitride (TaON) was formed by using the conditions shown in Example 1. In addition, a layer that was a mixture layer containing silicon oxide (SiO₂) was formed as the low-refractive-index layer 102a. In addition, a layer containing magnesium fluoride (MgF₂) was used as the outermost layer. To maximize the transmittance characteristic in the wavelength range from 400 nm to 700 nm, the physical thickness of each layer was optimized and the configuration of the optical film 102 was determined. FIG. 14A illustrates the material used for the optical element of Example 9, the physical thickness of each layer, and the refractive index for the wavelength of 550 nm.

The light transmittance of the optical element 100 having the configuration illustrated in FIG. 14A was measured at a light incident angle of 5°. FIG. 14B is a graph illustrating the light transmittance with respect to the wavelength of the light in the optical element 100 according to Example 9. An extremely good result that the average light transmittance in the wavelength range from 400 nm to 700 nm was 99.6% or higher was obtained, and a good result was obtained for also the antistatic property.

To be noted, although the optical element 100 of a transmitting type was manufactured by setting the wavelength range of ultraviolet light of a wavelength of 365 nm as a target in Example 8 and by setting the wavelength range of visible light from 400 nm to 700 nm as a target in Example 9, the configuration is not limited to these. The low-refractive-index material, the high-refractive index material, the number of layers, and the physical thickness may be set in accordance with the wavelength range in which the optical element 100 is used, to optimize the optical characteristics.

### Other Modification Examples

The present disclosure is not limited to the embodiments described above, and can be modified in many ways within the technical concept of the present disclosure. In addition, the effects described in the present embodiment are merely enumeration of the most preferable effects, and are not limited to the present disclosure.

According to the present disclosure, a technique advantageous for improving the antistatic property and the optical performance is provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-225669, filed Dec. 20, 2024, which is hereby incorporated by reference herein in its entirety.

What is claimed is:

1. An optical film disposed on a substrate and comprising one layer or a plurality of layers,
wherein at least one layer of the optical film contains metal oxide and metal oxynitride, and
wherein 80.0%≤[O]/([O]+[N])≤99.0% is satisfied, where [O] represents oxygen atom content in the at least one layer in at %, and [N] represents nitrogen atom content in the at least one layer in at %.

2. The optical film according to claim 1, wherein [O]/([O]+[N])≤98.4% is satisfied.

3. The optical film according to claim 1, wherein 93.5%≤[O]/([O]+[N]) is satisfied.

4. The optical film according to claim 1,
wherein 95.3%≤[O]/([O]+[N]) is satisfied, and
wherein 72.8%≤([O]+[N])/([M]+[O]+[N]) is satisfied, where [M] represents metal atom content in the at least one layer in at %.

5. The optical film according to claim 1,
wherein 95.3%≤[O]/([O]+[N]) is satisfied, and
wherein 75.0%≤([O]+[N])/([M]+[O]+[N]) is satisfied, where [M] represents metal atom content in the at least one layer in at %.

6. The optical film according to claim 5,
wherein [M−ON]/[M−O]≤5.0% is satisfied, where [M−ON] represents ionic strength originating from the metal oxynitride in analysis of the at least one layer by time-of-flight secondary ion mass spectrometry, and [M−O] represents ionic strength originating from the metal oxide in the analysis.

7. The optical film according to claim 1, wherein [O]/([O]+[N])≤95.3% is satisfied.

8. The optical film according to claim 1,
wherein the optical film includes the plurality of layers,
wherein the plurality of layers include one or more high-refractive-index layers and one or more low-refractive-index layers, and
wherein the at least one layer is at least one of the one or more high-refractive-index layers.

9. The optical film according to claim 8, wherein the one or more high-refractive-index layers are each a layer having a refractive index of 2.0 or higher with respect to light of a wavelength of 550 nm.

10. The optical film according to claim 9, wherein the high-refractive-index layer contains at least one metal element selected from the group consisting of Ta, Ti, Zr, V, Nb, and Cr.

11. An optical element comprising:
a substrate; and
the optical film according to claim 1 disposed on the substrate.

12. The optical element according to claim 11, wherein the substrate is formed from glass or plastics.

13. The optical element according to claim 11, wherein the optical film is an anti-reflection film.

14. An optical device comprising:
a device body; and
a casing covering at least part of the device body,
wherein the device body includes the optical element according to claim 11.
